(19) United States
(12) Patent Application Publication
(10) Pub. No.: US 2015/0271024 A1
(43) Pub. Date: Sep. 24, 2015

(54) METHOD OF AUTOMATIC NETWORK CONFIGURATION USING SENSING AND COOPERATIVE COMMUNICATION

(71) Applicant: National Taiwan University, Taipei (TW)

(72) Inventors: CHUN-TING CHOU, Taipei (TW); CHUN-YU CHEN, Tainan (TW)

(73) Assignee: National Taiwan University, Taipei (TW)

(21) Appl. No.: 14/571,324

(22) Filed: Dec. 16, 2014

(30) Foreign Application Priority Data
Mar. 24, 2014 (TW) 103110852

(51) Int. Cl. H04L 12/24

(52) U.S. Cl. CPC H04L 41/0886; H04L 41/0853; H04L 41/0856

(57) ABSTRACT

The invention provides a method of automatic network configuration using sensing and cooperative communication, which includes the following steps: detecting an environmental condition and/or user behavior information based on an operating status of a plurality of devices, transmitting and receiving a message of the environmental condition and/or the user behavior information between the plurality of devices, recording the received message by the plurality of devices, retrieving a device relationship according to the message, and performing automatic network configuration and connection according to device relationship.

### BACKGROUND OF THE INVENTION

1. Field of the Invention

The present invention generally relates to a method of automatic network configuration, and more particularly to a method of automatic network configuration via sensing and cooperative communication, which may automatically configure the network setting and operation setting based on an operating status of devices and the messages generated and transmitted between the devices without human intervention.

2. Description of Related Art

Due to the development of technology, users now have a much more convenient life by using the devices, which are able to connect with each other. Take a motion sensor and a lamp as an example. Users can set up a connection between a motion sensor and a lamp, so that the motion sensor may control the lighting status of the lamp. However, these setting procedures must be set by the user in advance. That is, a device is unable to self-connect to other devices of its interests without human intervention. Such human intervention usually causes much inconvenience to the users.

Referring to FIG. 1, FIG. 1 is a view illustrating a motion sensor being used to active a lamp according to the prior art. In the prior art, if the user wants a lamp to be controlled by a sensor S, the user needs to connect in advance the lamp a and the sensor S with each other, through a wire or wirelessly, so that when someone passes by the sensor S, the lamp would be activated by the sensor. That is to say, the devices such as the sensor S and the lamp a are unable to connect with each other until the user configures the two devices to do so. Although, in some prior art, some devices such as a Nest thermostat could configure its operation parameters according to the behaviors/habit of the users. However, the thermostat is a standalone device. If they need to be connected to user portable devices or other devices, the network connection still needs to be configured by users manually.

A need has thus arisen to propose a simple, fast and automatic method for automatically configuring the network (i.e., connection among devices) by the devices themselves, in accordance with the user behaviors/habits, user identity or the status of the devices. As a result, a user can use the services enabled by the connected devices without or with minimal manual configuration.

### SUMMARY OF THE INVENTION

An embodiment of the present invention provides a method of automatic network configuration using sensing and cooperative communication, including the following steps of detecting an environmental condition, operating statuses of a plurality of devices, and/or user behavior/identity, transmitting and receiving the environmental condition, operating statuses and/or the user behavior/identity between the plurality of devices; recording the received information by the plurality of devices; retrieving device relationship according to the received information and performing self-configuration automatically according to the device relationship.

In view of the foregoing, by the method of automatic network configuration, the data or the events may be transmitted, received and recorded between the devices, so that each device may identify the external environment conditions and user behavioral pattern so as to infer the device relationship, according to the data or the events. In particular, the devices of the present invention may infer the spatial relationship, the temporal relationship, the functional relationship, the feature relationship and the device type relationship for the automatic setting and connection. Thus, the method of the present invention may further combine the above device relationships to configure each device automatically based on the data transmitted, stored and analyzed by a purity of the devices. Therefore, the devices can connect to each other automatically based on environment condition and user behavior/habits in a simple, fast and automatic method. Accordingly, the present invention may be widely used to various devices.

### BRIEF DESCRIPTION OF THE DRAWINGS

FIG. 1 is a view illustrating a sensor being used to active a lamp according to the prior art;

FIG. 2 is a flow diagram of a method of automatic network configuration using sensing and cooperative communication according to an embodiment of the present invention;

FIG. 3A and FIG. 3B are flow diagrams of a method of automatic network configuration using sensing and cooperative communication according to an embodiment of the present invention; and

FIG. 4 is a view illustrating a method of automatic network configuration using sensing and cooperative communication according to another embodiment of the present invention.

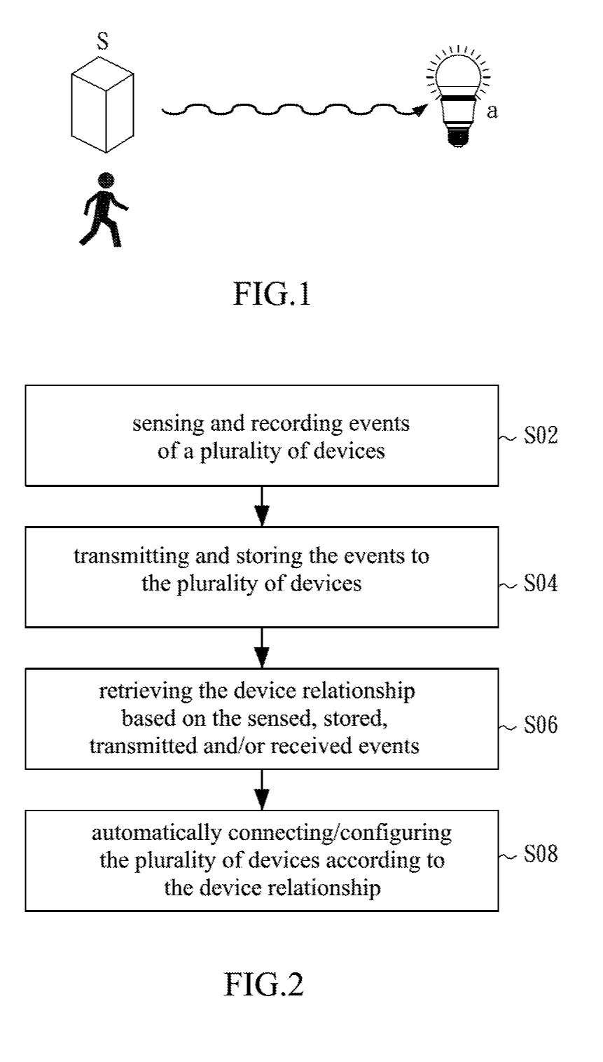

### DETAILED DESCRIPTION OF THE INVENTION

Referring to FIG. 2, FIG. 2 is a flow diagram of a method of automatic network configuration using sensing and cooperative communication according to an embodiment of the present invention. The method of automatic network configuration using sensing and cooperative communication includes following step; step S02, sensing and recording events of a plurality of devices; step S04, transmitting and storing the events to the plurality of devices; step S06, retrieving the device relationship based on the sensed, stored, transmitted and/or recorded events; and step S08, automatically connecting/configuring the plurality of devices according to the device relationship.

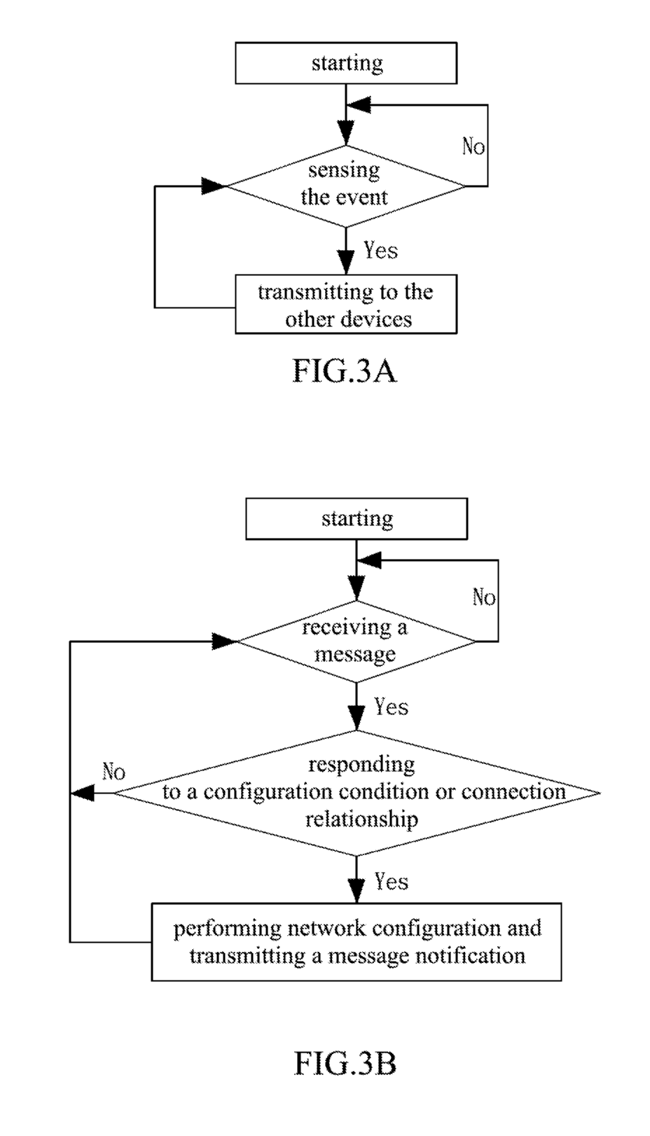

Referring to FIG. 3A and FIG. 3B, FIG. 3A and FIG. 3B are flow diagrams of a method for automatic network configuration according to an embodiment of the present invention. As shown in FIG. 3A, when the device senses the event such as the user operating the device, a message will be transmitted to the other devices. Then, after the message is transmitted to the other devices, each device will continue to sense if any other event occurs. On the other hand, when the device has not sensed the event or the user doesn't operate the device, each device will continue to sense if any event occurs. The message transmitted from the device may include device information, sensing information or user operation information. Sensing formation may include the ambient brightness, the temperature and/or the humidity, and the current time. Device information may include a device identification, a device type or a device position/status. User operation information may include user's action, user's operation status or his/her identity.

As shown in FIG. 3B, when the device receives the message from other devices, the message will be stored and analyzed. If the message is analyzed to satisfy a configuration condition or connection relationship, the device may automatically generate a network connection with other devices or alter its configuration, and broadcast a notification message to inform other devices of the action which has been done.

A plurality of signal transmitting modules are respectively disposed in each device, and each signal transmitting module transmits and receives a plurality of messages by wired or wireless communication technology, so that the messages can be transmitted between the devices. Furthermore, the capability of direct communication between the devices is unnecessary, as the devices may exchange the messages with each other by a communication gateway.

The messages received by the devices can be stored in storing units, and each storing unit includes a storing device such memory IC or hardware, which may be disposed in each device. Furthermore, the method of automatic network configuration using sensing and cooperative communication of the present invention may record usage conditions of each device for a period of time or cumulatively record usage conditions of each device, and then automatically configure each device or connect to other devices according to messages which have been stored, recorded and analyzed.

Moreover, the automatic network configurations of the present invention may differ from each other according to different inferred relationships. Simply speaking, as the relationship might be retrieved locally by each device, a device may decide to execute a corresponding action by itself. More particularly, the method for the automatic network configurations of the present invention may automatically configure each device, according to a spatial relationship, a temporal relationship, the functional relationship, the feature relationship and the device type relationship. The process of the configuration includes automatically changing the configurations and the connections between the devices, according to the messages received, recorded or stored from the devices, and the present invention is not limited thereto.

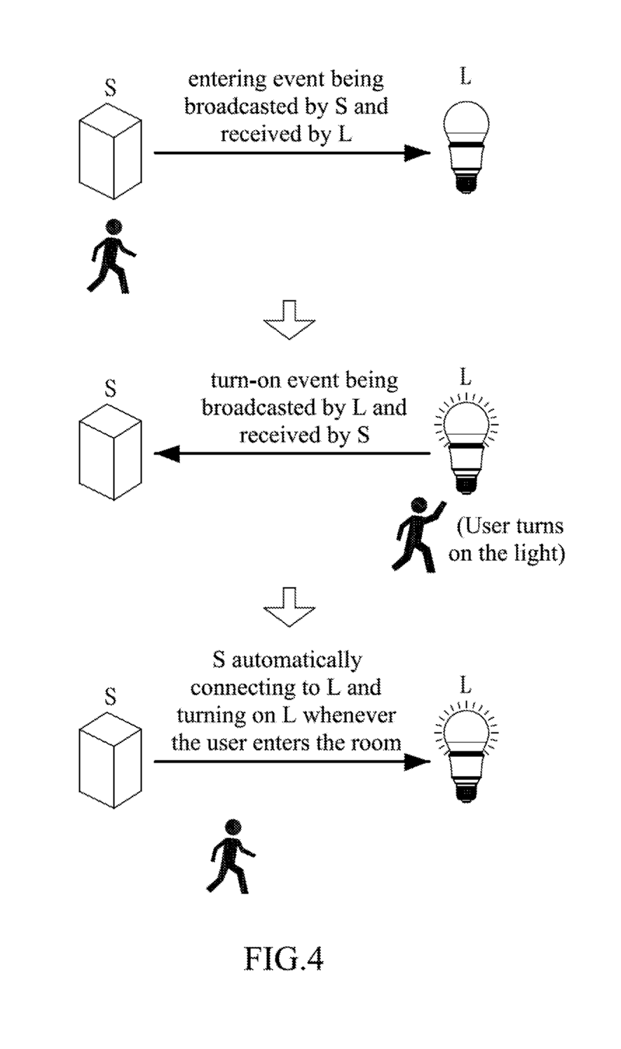

Referring to FIG. 4, FIG. 4 is a view illustrating a method of automatic network configuration using sensing and cooperative communication according to another embodiment of the present invention. In the embodiment, a sensor S and a lamp L are taken as an example. Although the sensor S and the lamp L are disposed in the same space (a room), the configuration of the sensor S and the lamp L is not preset at an initial state. When the sensor S senses the event indicating that the user enters the room, a storing unit disposed in the sensor S may record the event that the user enters the room, and then the signal transmitting module disposed in the sensor S may transmit the event to other devices. In the embodiment, the event is transmitted to all devices in the radio coverage of the sensor S. Therefore, a signal receiving module and a storing unit of the lamp L respectively receives and stores the event since the lamp L is within the radio coverage of the sensor S. Then, when the user turns on the lamp L right after entering the room, the signal transmitting module of the lamp L may transmit the event that the user turns on the lamp L to other nearby devices. In the embodiment, the event is received by the sensor S. Accordingly, by the received signal strength indicators (RSSI) of the sensor S and the lamp L, the sensor S and the lamp L may identify them being in the vicinity of each other, such that the spatial relationship is determined.

Furthermore, a storing unit disposed in the sensor S may confirm that the lamp L is turned on shortly after the user enters the room, according to the event time of the user entering the room detected by the sensor S and the user turn-on time which the sensor S receives from the lamp L. That is, the temporal relationship of the user operating the devices can be confirmed. Therefore, after the spatial relationship and the temporal relationship are confirmed, the sensor S may transmit the signal to the lamp L for connecting the lamp L. When the lamp L receives the signal and determines that the signal is transmitted from the sensor S (by confirming device type of the sensor 5, along with spatial and temporal relationship), the lamp L may then be automatically connected to sensor S. Accordingly, the automatic network setting can be established.

In other embodiment of the invention, a fan and an air conditioner are taken as example. When the user turns on the air conditioner, a signal transmitting module of the air conditioner may simultaneously transmit the user's operation messages to the other devices. In the embodiment, the other device is illustrated as a fan. If the user turns on the fan after the air conditioner being activated, a signal transmitting module of the fan will simultaneously transmit the event that the fan is turned on to other devices, especially to the air conditioner. Thus, the storing unit in each device may infer a temporal relationship between the devices, according to the user's operation sequence for activating the air conditioner and the fan. A connection between the air conditioner and the fan is then automatically established. Therefore, due to the automatic networking settings between the devices, it is unnecessary for the user to set up the connection between air conditioner and the fan.

Accordingly, the devices mentioned in the above embodiment of the present invention may generate an automatic network configuration according to features of the devices, but the devices in other embodiments may be used to combine such as a temporal relationship, a spatial relationship, a feature relationship or a device type relationship between the devices, and however the present invention is not limited thereto.

For example, in the above embodiment, the method of automatic network configuration using sensing and cooperative communication of the present invention may automatically connect a plurality of device according to a temporal relationship. The temporal relationship is an actuated sequence of the user operating the devices. Especially in the embodiment illustrated in FIG. 4, the method further combines a relative distance or a spatial relationship of the devices, a functional relationship, a device type relationship and a temporal relationship to set the devices automatically.

Moreover, in another embodiment, the method of automatic network configuration using sensing and cooperative communication of the present invention may include at least one gateway, which is configured to relay the data or transmit the event. For example, when the device A transmits the data or the event, the data is directly transmitted to the device B, or the data is indirectly transmitted to the gateway, and then the gateway transmits the data to the device B. Furthermore, the number of the gateways is not limited to one, but may be set according to the actual demand.

In view of the foregoing, by the method of automatic network configuration using sensing and cooperative communication of the present invention, the data or the events may be exchanged transmitted, received and recorded between the devices, so that each device may analyze the user behavioral pattern, and the external environmental states to retrieve the device relationship, according to the data or the events. In particular, the devices may obtain the spatial relationship, the temporal relationship, the functional relationship, the feature relationship and the device type relationship for the automatic network configuration and connection. Thus, the method of the present invention may further combine the above relationships to connect each device automatically by the data transmitted, received, stored and analyzed, so that the devices can be configured and connected in a simple, fast and flexible way. Accordingly, the present invention may be widely used to various devices.

What is claimed is:

1. A method of automatic network configuration using sensing and cooperative communication, comprising:
detecting an environmental condition and/or user behavior information based on an operating status of a plurality of devices;
transmitting and receiving a message of the environmental condition and/or the user behavior information between the plurality of devices;
recording the received message by the plurality of devices;
retrieving a device relationship according to the message; and
performing automatic network configuration and connection according to device relationship.

2. The method of claim 1, wherein the message is sensed by a plurality of signal sensing modules.

3. The method of claim 1, wherein the message is transmitted by a plurality of signal transmitting modules.

4. The method of claim 1, wherein the message is stored by a plurality of storing units.

5. The method of claim 1, wherein the device relationship includes a spatial relationship, a temporal relationship, a functional relationship, a feature relationship and a device type relationship.

6. The method of claim 5, further comprising:
automatically connecting and/or configuring the plurality of devices according. to the spatial relationship between the plurality of devices.

7. The method of claim 5, further comprising:
automatically connecting and/or configuring the plurality of devices according to the temporal relationship, wherein the temporal relationship is an activated sequence of a user operating the plurality of devices.

8. The method of claim 5, further comprising:
automatically connecting the plurality of devices according to the device type relationship.

9. The method of claim 5, further comprising:
automatically connecting the plurality of devices according to the functional relationship.

10. The method of claim 5, further comprising:
automatically connecting the plurality of devices according to the feature relationship.
